(19) United States
(12) Patent Application Publication
(10) Pub. No.: US 2025/0155858 A1
(43) Pub. Date: May 15, 2025

(54) A METHOD OF ENERGY MANAGEMENT FOR AN ELECTRICAL SYSTEM OF A BUILDING

(71) Applicant: EATON INTELLIGENT POWER LIMITED, Dublin 4 (IE)

(72) Inventors: Andrei Marinescu, Dublin (IE); Andrew Mckay, Dublin (IE); Colm Gallagher, Dublin (IE); James Fitzpatrick, Dublin (IE)

(21) Appl. No.: 18/720,772

(22) PCT Filed: Dec. 17, 2021
(86) PCT No.: PCT/EP2021/086442

§ 371 Date: Jun. 17, 2024

(51) Int. Cl. G05B 15/02; G06Q 10/04

(52) U.S. Cl. CPC G05B 15/02; G06Q 10/04

(57) ABSTRACT

Some embodiments relate to a method of energy management for an electrical system of a building. The electrical system comprises one or more inflexible energy assets and one or more flexible energy assets. The method comprises: obtaining power data for the electrical system; and operating the one or more flexible energy assets to balance electrical power in the electrical system by: determining an energy forecast for the electrical system based on the power data, wherein the energy forecast is determined using a forecasting model for the electrical system; and determining a power schedule for controlling the one or more flexible energy assets to balance the electrical power in the electrical system using the determined energy forecast.

### TECHNICAL FIELD

The present disclosure relates generally to a method of energy management for an electrical system of a building. Aspects of the disclosure relate to a method, to a building energy management system, and to a non-transitory, computer-readable storage medium.

### BACKGROUND

Traditionally, a building is provided with a single source of electrical energy (usually from the electrical grid) and the building includes a set of loads that draw electrical power from that source, as necessary. However, more recently, distributed energy resources are becoming more prevalent, particularly with the wider adoption of renewable energy systems, and building loads are becoming more dynamic due to the electrification of heat and transportation systems.

Accordingly, modern building energy systems may include multiple sources of energy, controllable building loads and even energy storage systems that can be selectively operated as either an energy load (during charging) or an energy source (during discharge). Accordingly, operating a modern building energy system is becoming increasingly complex.

It is against this background that the disclosure has been devised.

### SUMMARY OF THE DISCLOSURE

According to an aspect of the present disclosure there is provided a method of energy management for an electrical system of a building. The electrical system comprises one or more inflexible energy assets and one or more flexible energy assets. The method comprises: obtaining power data for the electrical system; and operating the one or more flexible energy assets to balance electrical power in the electrical system by: determining an energy forecast for the electrical system based on the power data, wherein the energy forecast is determined using a forecasting model for the electrical system; and determining a power schedule for controlling the one or more flexible energy assets to balance the electrical power in the electrical system using the determined energy forecast.

In this manner, the solution is advantageous in that it facilitates proactive planning of the power inputs to/outputs from the electrical system to balance the electrical system, mitigating or negating periods of outage or curtailment, reducing grid reliance and allowing for increased utilization of renewable energy sources.

Optionally, the method further comprises training the forecasting model based on the power data. For example, the forecasting model may be trained with a first frequency and the power schedule may be determined with a second frequency greater than the first frequency. In this manner, the forecasting model can be retrained to ensure that the energy forecast remains accurate as the energy assets and conditions change over time and the power schedule can be retrained more frequently, based on more recent power data, to minimise any control errors, that may otherwise lead to energy spillage for example.

The first frequency may be daily or monthly, for example. The second frequency may be at least hourly, for example, though the second frequency may be greater.

The power data used for training the forecasting model may be power data obtained for the interval succeeding the previous training iteration, for example. This ensures that forecasting model is retrain based on recent power data. The power data used for determining the energy forecast may be power data obtained for the interval succeeding the previous forecast determination, for example.

Optionally, the forecasting model for the electrical system includes an asset model for each inflexible energy asset. Optionally, the forecasting model for the electrical system may further include an asset model for each flexible energy asset.

Optionally, training the forecast module comprises determining each asset model as an asset-specific model for each inflexible energy asset by: obtaining an initial asset model prescribed for a respective type of inflexible energy asset; and training the initial asset model based on the obtained power data. For example, each initial asset model may be obtained from a datastore comprising a plurality of initial asset models associated with respective types of inflexible energy asset. The initial asset model may then be trained based on site-specific data to provide the asset-specific model for forecasting the power availability/demand at the building.

Each initial asset model may, for example, be determined for the respective type of inflexible energy asset during offline analysis and loaded into the datastore.

Optionally, the determined power schedule comprises a set-point schedule for a power input, and/or a power output, of each flexible energy asset for a forecast period.

Determining the power schedule may, for example, comprise: receiving one or more power balance objectives for the forecast period; and determining the power schedule to satisfy the one or more power balance objectives.

For example, the one or more power balance objectives may include one or more of: minimising an operating cost of the electrical system during the forecast period based on one or more energy tariffs; maximising a power input contribution of one or more renewable energy sources to the electrical system during the forecast period; minimising a power input contribution of one or more non-renewable energy sources to the electrical system during the forecast period; and/or maximising an availability of output power during the forecast period; maximising a power output of the electrical system during the forecast period.

Optionally, the one or more power balance objectives may be received through a user input device.

The one or more inflexible energy assets may, for example, include: one or more non-dispatchable energy sources, optionally, wherein the one or more non-dispatchable energy sources include a renewable energy system, such as a photovoltaic system and/or a wind energy system; and/or one or more inflexible building loads.

The one or more flexible energy assets may, for example, include: one or more building loads controllable by a building energy management system; one or more energy storage systems, e.g. battery energy storage systems (BESS), and/or electric vehicles supplied by EVSE; and/or a dispatchable energy source, optionally, wherein the dispatchable energy source includes a connected power grid.

Optionally, the electrical system includes N inflexible energy assets, where N is a positive integer, and wherein the obtained power data comprises one or more N-dimensional data points, each data point comprising a power measurement obtained for each of the N inflexible energy assets at a respective time.

According to another aspect of the disclosure, there is provided a non-transitory, computer-readable storage medium having instructions stored thereon that, when executed by a computer processor, cause the computer processor to carry out the method described in a previous aspect of the disclosure.

According to yet another aspect of the disclosure, there is provided an energy management system for an electrical system of a building comprising one or more inflexible energy assets and one or more flexible energy assets. The energy management system comprises: a sensor module configured to obtain power data for the electrical system; a forecast module configured to determine an energy forecast for the electrical system based on the power data, wherein the forecast module is configured to determine the energy forecast using a forecasting model for the electrical system; a power scheduling module configured to determine a power schedule for the one or more flexible energy assets to balance the electrical power in the electrical system, wherein the power scheduling module is configured to determine the power schedule using the determined energy forecast; and a dispatch module configured to control the one or more flexible energy assets based on the determined power schedule to balance the electrical power in the electrical system.

Optionally, the energy management system further comprises a training module configured to train the forecasting model based on the power data. The training module may, for example, be configured to train the forecasting model with a first frequency and the power scheduling module may be configured to determine the power schedule with a second frequency greater than the first frequency.

Optionally, the power data used for training the forecasting model is power data obtained for the interval succeeding the previous training iteration. Optionally, the power data used for determining the energy forecast is power data obtained for the interval succeeding the previous forecast determination.

It will be appreciated that preferred and/or optional features of each aspect of the disclosure may be incorporated alone or in appropriate combination in the other aspects of the disclosure also.

### BRIEF DESCRIPTION OF THE DRAWINGS

Examples of the disclosure will now be described with reference to the accompanying drawings, in which:

FIG. 1 shows a simplified schematic view of an energy system of a building controlled by a building energy management system;

FIG. 2 shows a schematic view of an exemplary building energy management system for controlling the electrical system shown in FIG. 1;

FIG. 3 shows the steps of an example method of operating the building energy management system shown in FIG. 2;

FIG. 4 shows exemplary sub-steps of the method shown in FIG. 3;

FIG. 5 shows further exemplary sub-steps of the method shown in FIG. 3;

FIG. 6 shows a schematic view of another exemplary building energy management system for controlling the electrical system shown in FIG. 1;

FIG. 7 shows the steps of an example method of operating the building energy management system shown in FIG. 6; and

FIG. 8 shows exemplary sub-steps of the method shown in FIG. 7.

### DETAILED DESCRIPTION

Embodiments of the disclosure relate to a method of energy management for an electrical system of a building, and to a building energy management system for implementing the method. The electrical system comprises one or more flexible energy assets and one or more inflexible energy assets. The inflexible energy assets are formed by one or more energy sources (such as intermittent or non-dispatchable energy sources) from which the availability of power is not controllable by the building energy management system and/or one or more energy loads having an energy demand that is not controllable by the building energy management system. In contrast, the flexible energy assets are controllable by the building energy management system. For example, the flexible energy assets may include one or more energy loads having a power demand that is controllable by the building energy management system in terms of its timing and/or the magnitude, for example. The one or more flexible energy assets may additionally, or alternatively, include one or more energy sources from which the availability of power is controllable by the building energy management system. For example, such energy sources may include dispatchable power energy sources, such as the electrical grid, and/or a fuel-powered generator system. Moreover, the one or more flexible energy assets may include one or more assets that are selectively operable as an energy source or an energy load, such as an energy storage system.

The method involves obtaining power data for the electrical system and operating the one or more flexible energy assets to balance the electrical power in the electrical system by: determining an energy forecast for the electrical system based on the power data; and determining a power schedule for controlling the one or more flexible energy assets based on the energy forecast.

In this respect, the energy forecast is determined using a forecasting model, where the method may be advantageously further configured to train the forecasting model based on the obtained power data. For example, the forecasting model may be trained based on power data obtained for the electrical system of the building during the course of the last 30 days, or another suitable period, and retrained at such a frequency, to ensure that the forecasting model accurately reflects the performance of the energy assets as conditions change over time, e.g. due to seasonal weather patterns and/or climate changes. The power schedule may similarly be redetermined, but at a greater frequency, using a small, but recent, set of the obtained power data, such as a period of hours or minutes, to determine accurate forecasts for a projected forecast period.

In this manner, the flexible energy assets may be controlled according to the determined power schedule to balance the power in the electrical system in an optimal manner, for example mitigating periods of outage, and/or curtailment, and minimising energy spillage. It is expected that the method of energy management will therefore provide various advantages over the traditional reactive approach to building energy management.

The building energy management system shall now be discussed in more detail with reference to an example electrical system of a building.

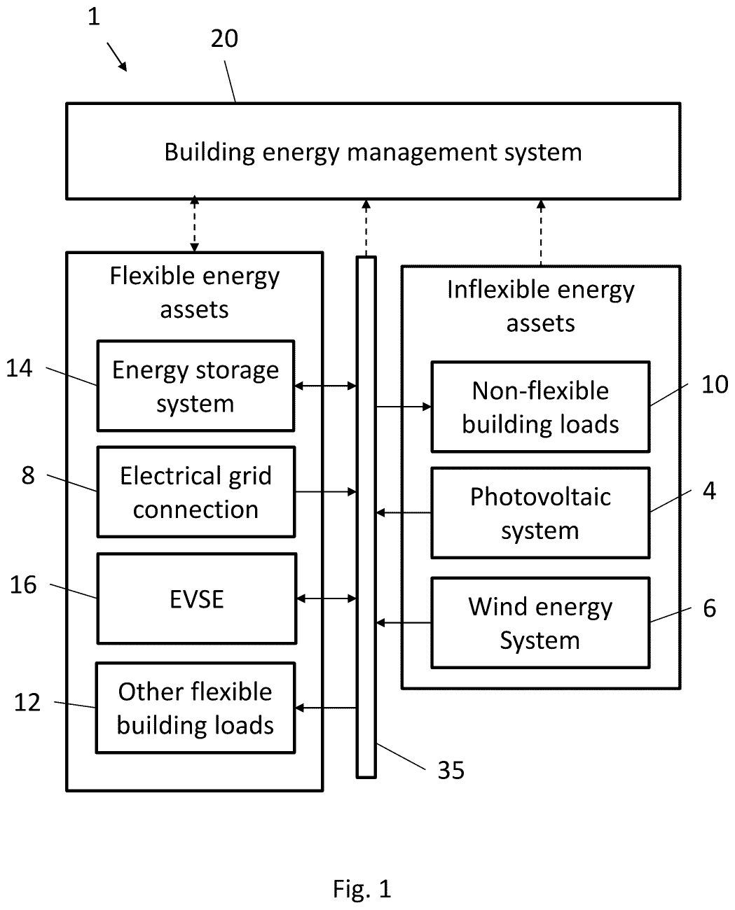

FIG. 1 schematically illustrates an example electrical system 1 of a building. The electrical system 1 is shown to include three general classes of energy assets: (i) energy sources that supply electrical power to the electrical system 1, (ii) energy loads that draw electrical power from the electrical system 1, and (iii) assets which can be operated as energy sources or energy loads. For example, the energy sources of the system 1 may include a photovoltaic system 4, a wind energy system 6, and a connection to an electrical grid or main power network 8, as shown in FIG. 1. The energy loads of the system 1 may include one or more inflexible building loads 10 having a non-scheduled power demand, and requiring an immediate power supply, such as the operation of various electrical appliances by individual(s) in the building. The energy loads of the system 1 may additionally, or alternatively, include one or more flexible building loads 12, such as heating systems, for which the power demand can be scheduled independently of the individual(s) in the building. The assets which can be operated as energy sources or energy loads may include energy storage systems, such as a battery energy storage system 14 and/or electrical vehicle supply equipment 16.

This example is not intended to be limiting on the scope of the invention though and, in other examples, it shall be appreciated that a different set of energy assets may be provided in the electrical system.

The energy sources and energy loads must be balanced across the energy system 1 at any one moment in time to avoid energy spillage or damage to the electrical components. However, some of the energy sources, such as the photovoltaic system 4 and the wind energy system 6, are non-dispatchable energy sources, from which power is only available intermittently. Consequently, such energy sources are unable to satisfy the non-flexible building loads during periods of outage.

A building energy management system 20 is therefore provided for determining a power schedule for the electrical system 1. In particular, the building energy management system 20 is configured to control a set of flexible energy assets 22 according to the determined power schedule to balance the electrical power in the electrical system 1.

As shown in FIG. 1, the set of flexible energy assets 22 includes the electrical grid connection 8, which is a dispatchable energy source, the flexible building loads 12, the battery energy storage system 14 and the electrical vehicle supply equipment 16, in this example. The remaining energy assets are inflexible energy assets 24, which include the photovoltaic system 4, the wind energy system 6 and the inflexible building loads 10.

In this context, it shall be appreciated that the flexible energy assets 22 relate to the energy loads having a power demand that is controllable by the building energy management system 20, at least in terms of the timing and/or the magnitude of the power demand, and the energy sources from which the availability of power is controllable by the building energy management system 20. In contrast, the inflexible energy assets 24 relate to the energy loads having an energy demand that is not controllable by the building energy management system 22, but rather by the individuals or other systems of the building, and the inflexible energy assets 24 also relate to the energy sources from which power availability is not controllable by the building energy management system 20, such as the non-dispatchable energy sources.

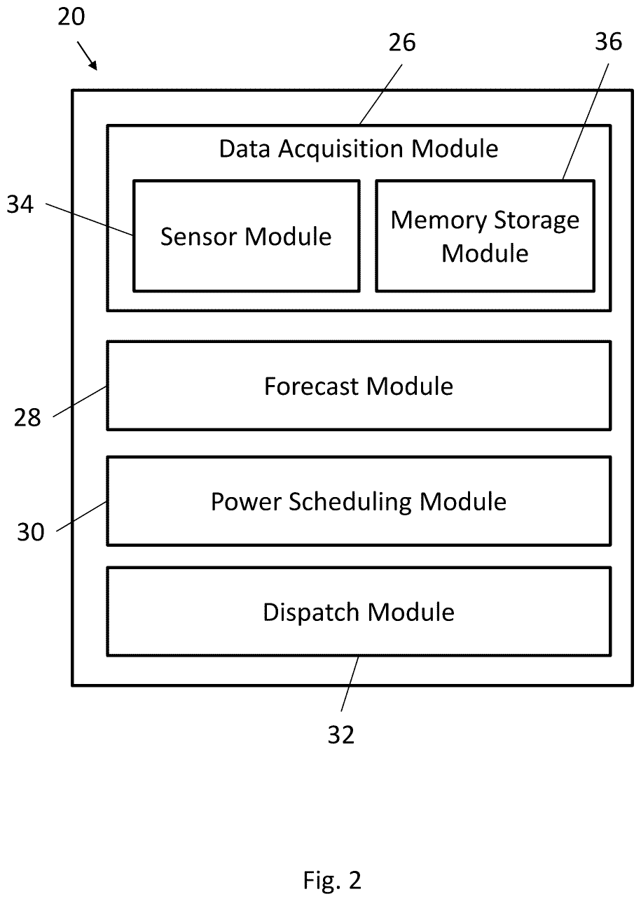

The building energy management system 20 shall now be considered in more detail with reference to FIG. 2, which illustrates a non-limiting example of the building energy management system 20.

The building energy management system 20 is connected to the electrical system 1 and may, for example, connect to each of the energy assets 22, 24 of the electrical system 1 via wired or wireless connections.

The role of the building energy management system 20 is to act as a command and control interface between the energy assets 22, 24 to balance the electrical power in the electrical system 1. The building energy management system 20 is therefore provided by a suitable computer system for carrying out the controls and commands as described herein.

As shown in FIG. 2, the building energy management system 20 may include a data acquisition module 26, a forecast module 28, a power scheduling module 30, and a dispatch module 32.

That is, in the described example four functional elements, units or modules are shown. Each of these units or modules may be provided, at least in part, by suitable software running on any suitable computing substrate using conventional or customer processors and memory. Some or all of the units or modules may use a common computing substrate (for example, they may run on the same server) or separate substrates, or different combinations of the modules may be distributed between multiple computing devices.

The data acquisition module 26 is configured to acquire power data for the electrical system 1. For this purpose, the data acquisition module 26 may include a sensor module 34 and a memory storage module 36. The sensor module 34 is configured to acquire power input and power output measurements for the electrical system 1 and may comprise, or connect to, one or more sensors (not shown) configured to measure the power supply, and/or the power draw, of each of the energy assets 22, 24 with respect to the electrical system 1. For example, the sensor module 34 may include one or more sensors connected to the electrical system 1 at a Point of Measurement (POM) 35, from which such measurements may be determined. In this manner, each data point of the acquired power data may comprise a respective power measurement obtained for each energy asset at a respective time.

The memory storage module 36 comprises a store or database of power data acquired by the sensor module 34. In examples, the acquired power data may be held in the memory storage module 36 temporarily, for example for a prescribed storage period. For example, the power data stored in the memory storage module 36 may be continuously, or periodically, updated or re-established to store power data acquired for the prescribed storage period. The data points may be pre-processed prior to addition to the database, for example such that the power measurements are reduced to critical components, such as current/voltage/power readings, timestamps and device identification numbers.

For the purpose of receiving and/or storing such data, the memory storage module 36 may take the form of a computer-readable storage medium (e.g., a non-transitory computer-readable storage medium). The computer-readable storage medium may comprise any mechanism for storing information in a form readable by a machine or electronic processors/computational device, including, without limitation: a magnetic storage medium (e.g., floppy diskette); optical storage medium (e.g., CD-ROM); magneto optical storage medium; read only memory (ROM); random access memory (RAM); erasable programmable memory (e.g., EPROM and EEPROM); flash memory; or electrical or other types of medium for storing such information/instructions.

In examples, the data acquisition module 26 may be further configured to acquire environmental data for the electrical system 1 including, for example, local weather and climate data for the building and/or the surrounding area, as well as cost data for the electrical system 1, such as an energy tariff for the electrical grid connection. For example, weather data can be collected via an external server, such as a 3rd party application programming interface (AFI), providing current and forecasted weather data based on location data or co-ordinates, such as global positioning system (GPS) co-ordinates, provided by the building energy management system 20. Energy tariff data can be input to the building energy management system 20 when the system is being commissioned by a technician, for example. Additionally, or alternatively, the energy tariff data may similarly be acquired from an API/database having energy tariffs for different utility providers.

The forecast module 28 is configured to determine or generate an energy forecast for the electrical system 1 based on the power data obtained by the data acquisition module 26. In particular, the forecast module 28 is configured to determine an energy forecast of the expected power availability/demands of the inflexible energy assets 22 based on the obtained power data. For example, the forecast module 28 may be configured to generate an energy forecast for the inflexible energy assets for a fixed period ahead of time, i.e. for a prescribed forecast period.

For this purpose, the forecast module 28 may include one or more forecasting models for the electrical system 1. For example, the forecast module 28 may include an asset model for each inflexible energy asset, where each asset model may be an asset-specific model trained based on historical data from the energy system 1 to forecast the power availability/demands of that inflexible energy asset 22. In this manner, the forecast module 28 may be configured to use the one or more forecasting models to generate a data-driven foresight, specific to that building, of the expected power availability/demands of the inflexible energy assets 22. Each asset model may further include static data, such as upper and lower power limits for the respective energy asset, which may be provided during the commissioning process or otherwise determined. For example, the asset model for the battery energy storage system 14 may include a maximum power output and/or a minimum current output, which may be provided during the commissioning process.

The forecast module 28 may further be configured to redetermine the energy forecast continuously, or periodically. For example, the forecast module 28 may be configured to redetermine the energy forecast hourly, or more frequently, such as every 5 minutes, as the power data obtained by the data acquisition module 26 is updated. For each iteration, the forecast module 28 may be configured to redetermine the energy forecast based on the power data acquired by the data acquisition module 26 since the previous energy forecast was determined. In this manner, a suitable compromise may be struck between forecasting accuracy and the length of the forecast period.

The power scheduling module 30 is configured to determine a power schedule to balance the electrical power in the electrical system 1 based on the generated energy forecast. In particular, the power scheduling module 30 is configured to determine a power schedule for the one or more flexible energy assets 24. For example, the determined power schedule may take the form of a set-point schedule of power inputs, and/or power outputs, of each flexible energy asset for respective times during the forecast period. In this manner, the determined set point schedule may adjust the power outputs/inputs from inflexible energy assets to balance the forecasted power availability/demands of the inflexible energy assets, for example satisfying the forecasted power demands without a power outage and making use of the forecasted power availability without energy spillage.

For this purpose, the power scheduling module 30 may include one or more optimisation algorithms or solvers, configured to determine the power schedule based on the energy forecast. For example, the power scheduling module 30 may include a mixed-integer linear programming solver for determining the power schedule, such as a Computational Infrastructure for Operations Research branch and cut mixed integer programming solver (also known as CBC), which is known in the art and is not described in detail here to avoid obscuring the invention.

In examples, the one or more optimisation algorithms or solvers of the power scheduling module 30 are configured to determine a power schedule for meeting one or more further power balancing objectives, such as minimising operating costs of the electrical system, maximising a power contribution from renewable energy sources, minimising a power contribution from non-renewable energy sources, and/or maximising power availability, while balancing the power of the electrical system 1. For example, the building energy management system 20 may further comprise, or connect to, a user input device (not shown), through which a user may be able to select, and/or to configure, further power balancing objectives for the electrical system 1.

The power scheduling module 30 may therefore be configured to map the power balancing objective(s) to a power scheduling function of the optimization solver to determine the power schedule for the flexible energy assets 24.

The dispatch module 32 is configured to dispatch the determined power schedule to the one or more flexible energy assets 24 to cause the flexible energy assets 24 to balance the power in the electrical power system. The dispatch module 32 may therefore be communicatively coupled to respective controllers of the flexible energy assets 24. As would be apparent to the skilled person, such controllers can be considered to be computer systems capable of operating the respective flexible energy assets 24 according to the respective set points of the power schedule, and may comprise multiple modules that control individual components of each flexible energy asset 24. In some examples, the building energy management system 22 may be connected directly to the flexible energy assets 24 without an intermediary controller and may dispatch set points accordingly. The dispatch of set points to the wind energy system 6, as an example, means that, where a power demand exists at a particular moment in time, the wind energy system 6 is configured to provide a power input contribution to the demand up to the power level prescribed by the respective set point. In this manner, the building energy management system 20 may for example, determine a power schedule with set-points that maximise the power input contribution from the wind energy system 6 during forecasted periods of relatively wind speed or power availability.

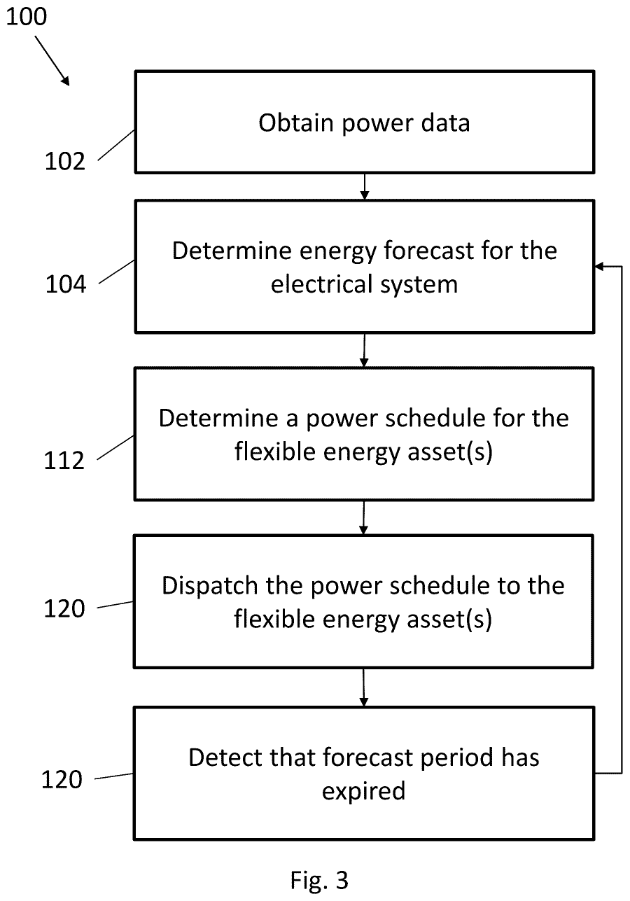

The operation of the building energy management system 20 in the example electrical system 1 shall now be described with additional reference to FIGS. 3 to 6.

FIG. 3 shows an example method 100 of operating the building energy management system 20 in the electrical system 1, in accordance with an embodiment of the disclosure.

In step 102, the building energy management system 20 obtains power data for the electrical system 1. For example, the building energy management system 20 may operate the data acquisition module 26 to monitor the electrical system 1 and thereby to obtain power data from each energy asset 22, 24 of the electrical system 1. The power data may be determined continuously, or periodically, in this manner, for example, being acquired at a predetermined sampling frequency. The obtained power data may therefore include a plurality of data points, each data point comprising a respective power measurement for each of the energy assets 22, 24 at a respective time. The data acquisition module 26 may obtain the power data using the sensor module 34 and store the power data permanently or temporarily in the memory storage module 26, for example. During this time the data acquisition module 20 may also acquire corresponding environmental data, such as weather and/or climate conditions, and store such data alongside the power data in the memory storage module 36.

In step 104, the building energy management system 20 determines an energy forecast for the electrical system 1 based on the obtained power data. In particular, the obtained power data is provided as an input to the forecasting model of the electrical system 1 in order to determine an energy forecast for prescribed forecast period.

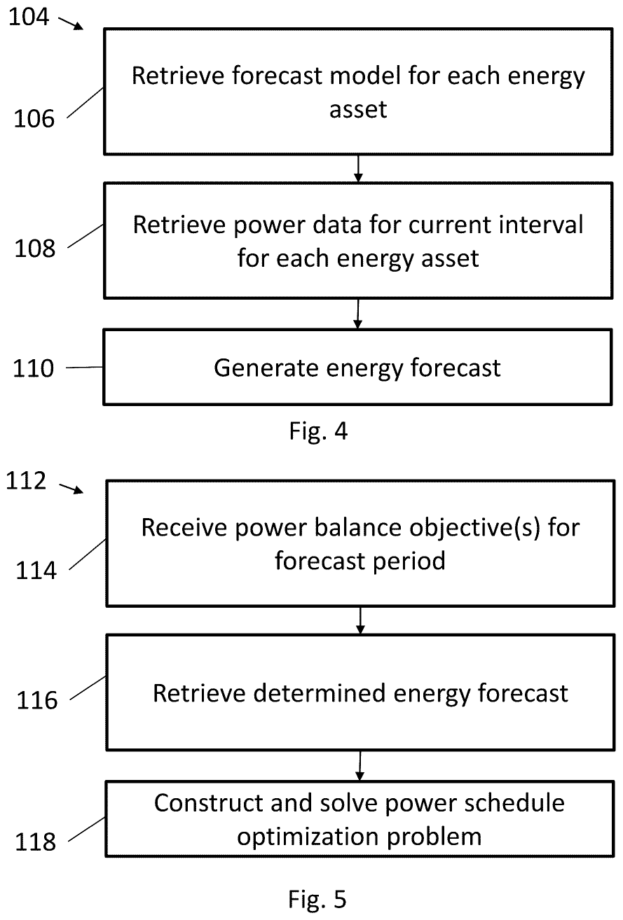

By way of example, FIG. 4 is provided to illustrate example sub-steps for determining the energy forecast.

In sub-step 106, the building energy management system 20 retrieves the forecasting model for the electrical system 1, which may comprise the asset model for each inflexible energy asset 22.

In sub-step 108, the building energy management system 20 retrieves a current data point and, optionally, one or more historical data points from the power data in the memory storage module 36 for the purposes of generating the forecast. For example, the forecast module 28 may be configured to generate the energy forecast based on a series of data points acquired during the course of a prescribed period, such as the previous hour. The extent of data required for generating the energy forecasts for each energy asset 22, 24 may be prescribed by the forecasting model or the respective asset models, for example. In examples, the asset models may therefore prescribe the acquisition of further environmental data for forecasting purposes. For example, the asset model for the photovoltaic system 4 may prescribe the use of current and/or forecasted local weather data in the energy forecasting process. Accordingly, in sub-step 108, the data acquisition module 26 may be further configured to acquire or retrieve such weather data from an external server, such as a 3^{rd} party API, for each of the data points.

In sub-step 110, the building energy management system 20 generates the energy forecast by applying the obtained power data as an input to the energy forecasting model. For example, each asset model may be provided with respective power measurements in the retrieved power data to determine a forecast of the expected power demand/availability of the respective inflexible energy asset 22. To give an example, the asset model for the photovoltaic system 4 may be provided with the power data acquired, in sub-step 108, along with the environmental data, such as current and/or forecasted weather conditions for the building. On this basis, the asset model for the photovoltaic system 4 may determine a forecast of the expected power availability, comprising a series of power estimates for the forecasted period.

In this manner, the determined energy forecast may therefore include a schedule of available power/power demand for each inflexible energy asset 22 during the course of the forecast period.

Returning to FIG. 3, in step 112, the building energy management system 20 is configured to determine the power schedule for controlling the flexible energy assets 24 to balance the electrical power in the electrical system 1 using the determined energy forecast.

There are multiple solutions to this power balancing problem at any given moment in time, hence this method proposes the use of optimization techniques to solve the problem with respect to one or more objective functions. Examples of relevant objective functions include minimizing operating costs, maximising the consumption of on-site generated renewables and minimizing the carbon dioxide emissions that the electrical system 1 generates.

The use of a total system-wide boundary on the optimization problem ensures that each energy asset 22, 24 is operated with respect to the total system objective, rather than that of any one asset 22, 24 in isolation.

In an example, shown in FIG. 5, the method 100 may therefore further comprise sub-steps 114 to 118 for determining the power schedule.

In sub-step 114, the building energy management system 20 receives the power balancing objective(s) which may include one or more power balancing objective(s) selected by a user or otherwise prescribed for the prevailing conditions. For example, one or more power balancing objective(s) may be prescribed for certain conditions of the electrical system 1, such as a time of day, a time of year, or according to particular weather conditions, as may be determined by the data acquisition module 26.

To give an example, the power objectives may include minimizing the cost of operating the electrical system 1, whilst balancing the electrical power. For this purpose, the data acquisition module 26 may therefore retrieve or acquire energy tariff data for the electrical grid connection 8.

In sub-step 116, the building energy management system 20 maps the power balancing objective(s) to a power scheduling function that the optimization solver can comprehend and provides the energy forecast, determined in step 104, as an input to the optimization solver. The power scheduling function may access one or more further data sources such as the reported energy tariffs to ensure any importing or exporting of electricity to/from the electrical grid is done in a cost sensitive manner with respect to the objectives of the end-user.

In sub-step 118, the building energy management system 20 determines the power schedule for the forecast period. For example, the optimization solver may process the energy forecast and solve the optimisation problem to determine a set-point schedule of power inputs, and/or power outputs, for each flexible energy asset 24 at respective times during the forecast period.

Returning to FIG. 3, in step 120, the building energy management system 20 outputs the determined power schedule to the flexible energy assets 24, causing the flexible energy assets 24 to adjust the power inputs to/outputs form the electrical system 1 accordingly to balance the electrical power in the electrical system 1 during the course of the forecast period. In particular, the power schedule may be output to the flexible energy assets 24 to generate control signals including parameters, such as limits or demands of how much energy to import or export from the energy asset at a given moment in time.

In this manner, the method utilizes forecasting and optimization techniques to implement a pro-active energy management system. The use of forecasting techniques allows the optimization-driven control module to understand any future demands on the system and thus, it accounts for the intermittence of certain energy sources and any variability in energy tariffs. For example, when the available power of the renewable energy systems, such as the photovoltaic system 4 and the wind energy system 6, exceeds the power demand of the inflexible building loads 10, the excess power may be directed to the flexible energy assets 24, for example to power the flexible building loads 12, and/or to charge the battery energy storage system 14 and/or the electrical vehicle supply equipment 16. Similarly, in the absence of available power from the renewable energy systems, the battery energy storage system 14, and/or the electrical vehicle supply equipment 16 can be controlled to discharge energy from an active power store and thereby satisfy the energy loads with minimal power draw from the electrical grid 8, or entirely without such power draw.

In the example shown in FIG. 3, the method 100 further includes step 122, which involves determining that the forecast period has expired or that another condition for re-determining the energy forecast has occurred.

Accordingly, upon determining that the forecast period has expired, the building energy managements system 20 may proceed to redetermine the energy forecast and the respective power schedule, according to steps 104 to 120, based on further power data that has been acquired by the data acquisition module 26, in step 102, in the period that has elapsed since the previous forecast.

In this manner, the building energy management system 20 can produce more accurate forecasts of the power availability/demand, and redetermine the forecast and power schedule accordingly based on current data, to minimise forecasting errors. Accordingly, the method 100 ensures that the changing state of the electrical system 1 is accounted for in the optimization problem

It is expected that the building energy management system 20 can therefore leverage the site-specific data to forecast the demand and availability of power in the electrical system 1 and proactively control the flexible energy assets 24 to balance the electrical power in the electrical system 1 in an optimal manner, for example making maximal utilisation of renewable energy sources, such as the photovoltaic system 4 and the wind energy system 6.

It is noted that the steps of the method 100 are only provided as a non-limiting example of the disclosure though and many modifications may be made to the above-described examples without departing from the scope of the appended claims.

For example, other embodiments of the invention within the scope of the appended claims, may include steps of training the forecasting models, and re-training the forecasting models with a particular frequency, to ensure that the forecasting models accurately predict the operations of the energy assets 22, 24 as conditions change over time.

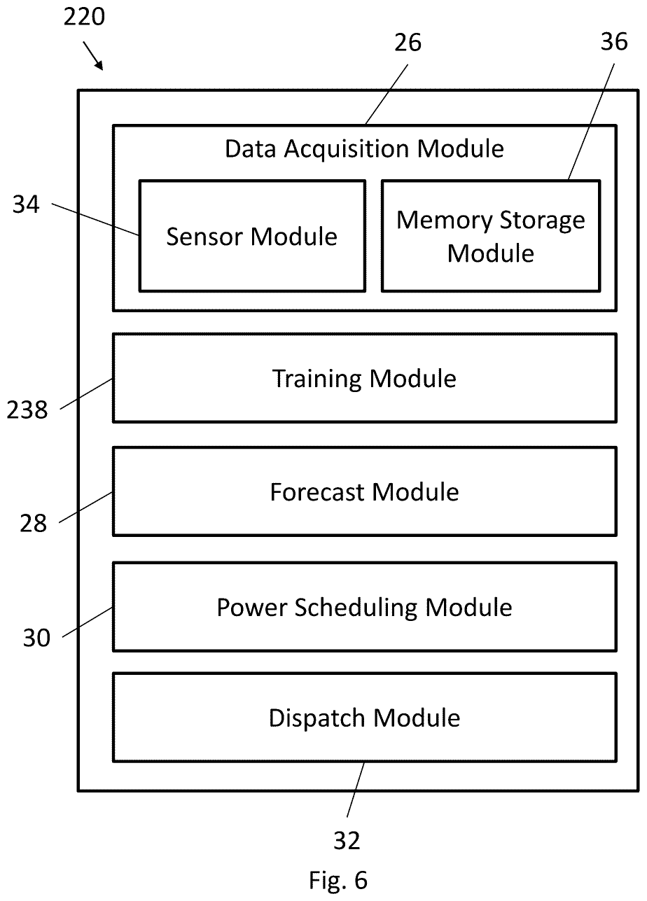

For this purpose, a further building energy management system 220 shall now be considered in more detail with reference to FIG. 6. The building energy management system 220 is substantially identical to the building energy management system 20, described in the previous example, and includes a data acquisition module 26, a forecast module 28, a power scheduling module 30, and a dispatch module 32, as described previously.

However, in this example, the building energy management system 220 further includes a training module 238 configured to train the forecasting model of the electrical system 1. In particular, the training module 238 is configured to train the forecasting model based on the obtained power data in order to produce a site-specific forecasting model. For example, for each inflexible energy asset 22, the training module 238 may be configured to retrieve a corresponding initial asset model from a datastore and to train the initial asset model based on site-specific power data associated with the operation of that energy asset 22. For example, the datastore may include respective initial asset models for different types of energy assets, including respective initial asset models for a range of renewable energy systems, such as photovoltaic systems, wind energy systems, and for the inflexible building loads of different types of buildings. To give an example, for a solar photovoltaic system, a multi-layer perceptron (MLP) neural network may provide a suitable initial asset model to be trained based on site-specific power data. The initial asset model may contain all the pre-processing required for the respective energy asset and be configured to source any external data (e.g. sourcing weather data for input into the MLP in the case of solar photovoltaic assets), as required alongside the obtained power data to train the asset model. To give another example, in the case of the non-flexible building loads, for certain building applications a long short-term memory (LSTM) recurrent neural network (RNN) may provide a suitable initial asset model. In each case, the definition of the appropriate initial asset model for each type of energy asset may be determined in offline analysis and stored accordingly in the datastore of the training module 238.

The training module 238 may therefore be configured to access the power data stored in the memory storage module 36 and retrieve historical power data for training the forecasting model. In this respect, the amount of historical data required may be expected to vary depending on the forecasting technique used and the variance in the quantity being forecast itself. For example, 30 days of historical data can be enough to train an accurate solar photovoltaic (PV) forecasting model where the pattern of energy generation is relatively consistent. However, if there is more variance that expected in this generation, 30 days may be insufficient to get a suitably accurate model and additional historical data may be required. Accordingly, the training module 238 may include prescribed amounts of historical data for training the forecasting model and take further historical power data into account as necessary to verify the accuracy of the forecasting model, against an accuracy threshold, for example.

The training module 238 may further be configured to retrain the forecasting model at a prescribed frequency. For example, the training module 238 may be configured to retrain the forecasting model monthly or less frequently, such as annually, if the asset performances are relatively stable. For each iteration, the training module 238 may be configured to retrain the forecasting model based on the power data acquired by the data acquisition module 26 since the previous training model was determined, for example.

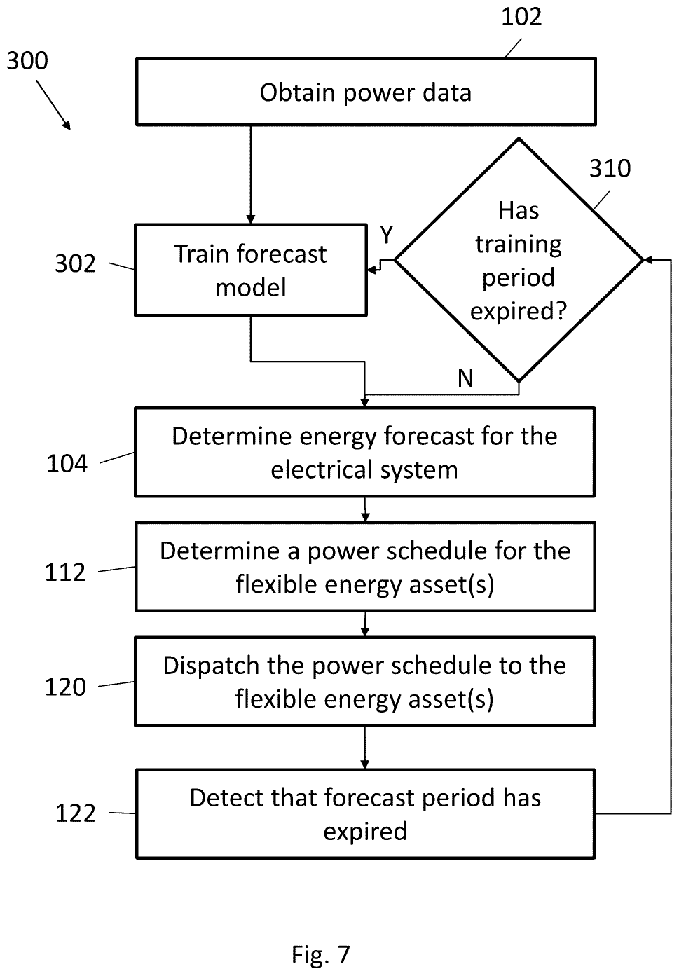

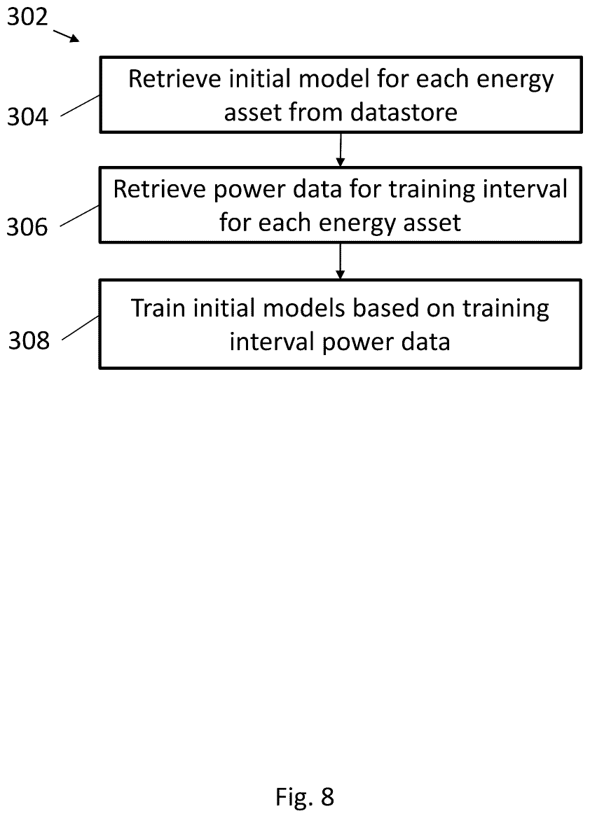

The operation of the building energy management system 220 in the example electrical system 1 shall now be described with additional reference to FIGS. 7 and 8.

FIG. 7 shows an example method 300 of operating the building energy management system 220 in accordance with an embodiment of the disclosure.

In step 102, the building energy management system 220 obtains the power data for the electrical system 1, substantially as described in the method 100.

In step 302, the building energy management system 220 trains the forecasting model based on the obtained power data.

To give an example, the method 100 may therefore further comprise sub-steps 304 to 312 for training the forecasting model, as shown in FIG. 8.

In sub-step 304, the building energy management system 220 retrieves an initial asset model prescribed for each energy asset from the datastore. For example, the building energy management system 220 may retrieve an initial asset model for the photovoltaic system 4 that takes the form of a multi-layer perceptron neural network. The building energy management system 220 may additionally, or alternatively, retrieve an initial asset model for the inflexible building loads 10 that takes the form of a long-short term memory (LSTM) recurrent neural network.

In sub-step 306, the building energy management system 220 retrieves power data for training the forecasting model. For example, the building energy management system 220 may retrieve a current data point and a set of historical data points from the memory storage module 36 for a prescribed training period. For example, the training module 238 may be configured to retrieve a series of data points acquired during the course of the previous month or year. In examples, the initial asset models may prescribe the acquisition of further environmental data for training purposes. For example, the initial asset model for the photovoltaic system 4 may prescribe the use of local weather data in the training process. Accordingly, in sub-step 306, the data acquisition module 26 may be further configured to acquire such weather data from an external server, such as a 3^{rd} party API, for each of the data points.

In sub-step 308, the building energy management system 220 trains the initial asset models based on the respective power measurements in the retrieved power data to determine the asset-specific models. Training processes for forecasting models are well-known in the art and are not described in detail here to avoid obscuring the invention. However, it shall be appreciated that the accuracy of each asset model may subsequently be verified before the asset model is approved for use in the forecasting model.

To give an example, the multi-layer perceptron neural network (used as an initial asset model for the photovoltaic system 4) may be trained using a back-propagation method, taking into account the acquired weather measurements and respective power measurements of the photovoltaic system 4. The LSTM recurrent neural network (used as an initial asset model for the inflexible building loads 10) may similarly be trained using an adaptive learning rate optimization algorithm that is known in the art, such as an Adam optimization algorithm.

Returning to FIG. 7, once suitable asset models have been determined for each inflexible energy asset 22, the method 300 proceeds to determine the energy forecast for the electrical system 1, in step 104, using the trained forecasting model, and determines and dispatches the power schedule to the flexible energy assets 24, in steps 104 to 120, substantially as described previously.

In this manner, it is expected that the method 300 will provide for enhanced forecasting accuracy ensuring that the building energy management system 320 balances the electrical power in the system 1 in an optimal manner.

Thereafter, the method 300 determines, in step 122, that the forecast period has expired. However, in this example, before the building energy management system 220 re-determines the energy forecast and the power schedule, the building energy management system 220 checks, in step 310, whether a prescribed training period has elapsed since the forecasting model was previously trained. Here it shall be appreciated that the frequency with which the energy forecast and the power schedule are redetermined is greater than the frequency with which the forecasting model is re-trained. For example, the power schedule may be re-determined hourly or at shorter intervals, such as every 5 minutes, whilst the forecasting model may be re-trained monthly or at even longer intervals, such as annually. Accordingly, the building energy management system 22 will usually determine, in step 310, that the prescribed training period has not yet elapsed and proceed to redetermine the energy forecast and the power schedule, according to steps 104 to 120, substantially as described previously.

However, when the building energy management system 220 determines, in step 310, that the prescribed trained period has elapsed since the forecasting model was last trained, the building energy management system 220 proceeds to retrain the forecasting model in step 302. It shall be appreciated that for the purposes of retraining the forecasting model the building energy management system 220 is configured to retrieve more recent power data that has been obtained in the interval since the forecasting model was previously trained, for example. In this manner, the forecasting model, and the asset models thereof, are retrained based on more recent power-data to ensure that the forecasts of the power demand/availability remain accurate as the asset performance and conditions, such as weather conditions, change.

In this manner, it is expected that the method 300 will provide for enhanced forecasting accuracy with a dynamically retrained forecasting model ensuring that the building energy management system 320 continues to balance the electrical power in the system 1 in an optimal manner as asset performance changes with time.

1. A method of energy management for an electrical system of a building, the electrical system comprising one or more inflexible energy assets and one or more flexible energy assets, the method comprising:
obtaining power data for the electrical system; and
operating the one or more flexible energy assets to balance electrical power in the electrical system by:
determining an energy forecast for the electrical system based on the power data, wherein the energy forecast is determined using a forecasting model for the electrical system; and
determining a power schedule for controlling the one or more flexible energy assets to balance the electrical power in the electrical system using the determined energy forecast.

2. A method according to claim 1, further comprising training the forecasting model based on the power data wherein the forecasting model is trained with a first frequency and the power schedule is determined with a second frequency greater than the first frequency.

3. (canceled)

4. A method according to claim 32, where the first frequency is one among: daily, monthly, at least hourly.

5. (canceled)

6. A method according to claim 2, wherein the power data used for training the forecasting model is power data obtained for the interval succeeding the previous training iteration.

7. A method according to claim 2, wherein the power data used for determining the energy forecast is power data obtained for the interval succeeding the previous forecast determination.

8. A method according to claim 1, wherein the forecasting model for the electrical system includes an asset model for each inflexible energy asset.

9. A method according to claim 8, wherein training the forecast module comprises determining each asset model as an asset-specific model for each inflexible energy asset by: obtaining an initial asset model prescribed for a respective type of inflexible energy asset; and training the initial asset model based on the obtained power data.

10. A method according to claim 9, wherein each initial asset model is obtained from a datastore comprising a plurality of initial asset models associated with respective types of inflexible energy asset and, wherein each initial asset model is determined for the respective type of inflexible energy asset during offline analysis and loaded into the datastore.

11. (canceled)

12. A method according to claim 1, wherein the determined power schedule comprises a set-point schedule for a power input, and/or a power output, of each flexible energy asset for a forecast period.

13. A method according to claim 12, wherein determining the power schedule comprises:
receiving one or more power balance objectives for the forecast period; and
determining the power schedule to satisfy the one or more power balance objectives.

14. A method according to claim 13, wherein the one or more power balance objectives include one or more of:
minimising an operating cost of the electrical system during the forecast period based on one or more energy tariffs;
maximising a power input contribution of one or more renewable energy sources to the electrical system during the forecast period;
minimising a power input contribution of one or more non-renewable energy sources to the electrical system during the forecast period; and/or
maximising an availability of output power during the forecast period;
maximising a power output of the electrical system during the forecast period.

15. A method according to claim 13, wherein the one or more power balance objectives are received through a user input device.

16. A method according to claim 1, wherein the one or more inflexible energy assets includes:
one or more non-dispatchable energy sources, optionally, wherein the one or more non-dispatchable energy sources include a renewable energy system, such as a photovoltaic system and/or a wind energy system; and/or
one or more inflexible building loads.

17. A method according to claim 1, wherein the one or more flexible energy assets includes:
one or more building loads controllable by a building energy management system;
one or more energy storage systems, e.g. battery energy storage systems (BESS), and/or electric vehicles supplied by EVSE; and/or
a dispatchable energy source, optionally, wherein the dispatchable energy source includes a connected power grid.

18. A method according to claim 1, wherein the electrical system includes N inflexible energy assets, where N is a positive integer, and wherein the obtained power data comprises one or more N-dimensional data points, each data point comprising a power measurement obtained for each of the N inflexible energy assets at a respective time.

19. A non-transitory, computer-readable storage medium having instructions stored thereon that, when executed by a computer processor, cause the computer processor to carry out the method of claim 1.

20. An energy management system for an electrical system of a building comprising one or more inflexible energy assets and one or more flexible energy assets, the energy management system comprising:
a sensor module configured to obtain power data for the electrical system;
a forecast module configured to determine an energy forecast for the electrical system based on the power data, wherein the forecast module is configured to determine the energy forecast using a forecasting model for the electrical system;
a power scheduling module configured to determine a power schedule for the one or more flexible energy assets to balance the electrical power in the electrical system, wherein the power scheduling module is configured to determine the power schedule using the determined energy forecast; and
a dispatch module configured to control the one or more flexible energy assets based on the determined power schedule to balance the electrical power in the electrical system.

21. An energy management system according to claim 20, further comprising a training module configured to train the forecasting model based on the power data wherein the training module is configured to train the forecasting model with a first frequency and the power scheduling module is configured to determine the power schedule with a second frequency greater than the first frequency.

22. (canceled)

23. An energy management system according to claim 22, wherein the power data used for training the forecasting model is power data obtained for the interval succeeding the previous training iteration.

24. An energy management system according to claim 22, wherein the power data used for determining the energy forecast is power data obtained for the interval succeeding the previous forecast determination.
